(19) United States
(12) Patent Application Publication
(10) Pub. No.: US 2011/0221886 A1
(43) Pub. Date: Sep. 15, 2011

(54) PATTERN DEFECT INSPECTING APPARATUS AND METHOD

(76) Inventors: Hidetoshi Nishiyama, Hitachinaka (JP); Masaaki Ito, Hitachinaka (JP); Sachio Uto, Yokohama (JP); Kei Shimura, Mito (JP)

(21) Appl. No.: 13/059,908

(22) PCT Filed: Jul. 8, 2009
(86) PCT No.: PCT/JP2009/062770

§ 371 Date: May 23, 2011

(30) Foreign Application Priority Data
Aug. 20, 2008 (JP) 2008-211275

(51) Int. Cl. H04N 7/18

(52) U.S. Cl. 348/126; 348/E07.085

(57) ABSTRACT

In recent years, a wafer inspection time in semiconductor manufacturing processes is being required to be reduced for reduction in manufacturing time and for early detection of yield reduction factors. To meet this requirement, there is a need to reduce the time required for inspection parameter setup, as well as the time actually required for inspection. Based on the speed or position change information relating to a transport system 2, inspection is also conducted during acceleration/deceleration of the transport system 2 by controlling an accumulation time and/or operational speed of a detector or by correcting acquired images. Alternate display of review images of a detection region at fixed time intervals improves visibility of the detection region and makes it possible to confirm within a short time whether a defect is present.

### TECHNICAL FIELD

The present invention relates to a pattern defect inspecting apparatus and method for detecting circuit pattern defects (short circuits, line disconnections, etc.) and foreign matter on a sample. Samples to be inspected using the pattern defect inspecting apparatus and method are semiconductor wafers, liquid-crystal displays, photomasks, hard-disk drives, patterned media, and other objects having circuit patterns. The following description envisages semiconductor wafers as an example of a sample, and also assumes that defects include foreign matter.

### BACKGROUND ART

In semiconductor manufacturing processes, the presence of defects on a wafer causes improper electrical interconnections, improper insulation of capacitors, electrical short circuit, damage to gate oxide films, or the like, and results in semiconductor device defectives. The sources of defects include, for example, the dust stemming from a movable section of a transport device, and/or the reaction products arising from processing in a manufacturing apparatus.

In recent years, semiconductor devices are becoming structurally complex and diverse. For example, these devices are divided into memory products, which are formed primarily by iterative patterning, and logic products, which are formed primarily by non-iterative patterning, the logic products being intricate in circuit pattern shape. In addition, since the manufacturing yield of semiconductor devices needs to be improved within a short period of time because of their short product lives, importance is being attached to reliably locating defects on wafers.

Scanning electron microscope (SEM) inspection and optical inspection are generally known as techniques for inspecting defects on a wafer as described above. The optical inspection technique is subdivided into brightfield inspection and darkfield inspection. Brightfield inspection is a technique that includes illuminating the wafer through an objective lens and converging upon the objective lens the light reflected/diffracted from the wafer. Brightfield inspection further includes converting the converged light into electrical signal form with a detector, and detecting defects by signal processing. Darkfield inspection is a technique that includes illuminating the wafer from the outside of NA (Numerical Aperture) of an objective lens and converging scattered light upon the objective lens. Darkfield inspection further includes defect detection based on signal processing of the converged light, as with the brightfield inspection technique.

Patent Document 1 discloses a highly sensitive and highly reliable inspection method relating to foreign matter and defects, as one form of optical darkfield inspection technology. In the inspection method according to Patent Document 1, generation of pattern-based spurious or false signals can be prevented by irradiating a wafer with laser light, then detecting the light scattered from foreign matter, and comparing detection results with inspection results that have been obtained for an immediately previous wafer of the same product type.

In addition, Patent Documents 2 to 4 disclose methods of detecting defects with high defect detection sensitivity by irradiating a wafer with coherent light and spatially filtering out the light arising from iterative patterns on the wafer.

Furthermore, Patent Document 5 discloses a configuration including a load correction mechanism installed at a symmetrical position with respect to a rotational axis of an X-Y stage mechanism in order to reduce stage vibration.

Moreover, Patent Document 6 discloses a method for periodically alternating a display screen between display of an image created from design drawings of circuit patterns, and display of an image of actual circuit patterns.

### PRIOR ART REFERENCES

### Patent Documents

Patent Document 1: JP-62-89336-A
Patent Document 2: JP-1-117024-A
Patent Document 3: JP-4-152545-A
Patent Document 4: JP-5-218163-A
Patent Document 5: JP-6-308716-A
Patent Document 6: JP-6-258242-A

### SUMMARY OF THE INVENTION

### Problem to be Solved by the Invention

In recent years, a wafer inspection time in semiconductor manufacturing processes is being required to be reduced for reduction in manufacturing time and for early detection of yield reduction factors. To meet this requirement, there is a need to reduce the time required for inspection parameter setup, as well as the time actually required for inspection.

Under these circumstances, the scheme of inspecting an entire wafer surface while scanning it with an X-Y stage is the mainstream in patterned-wafer inspection techniques. This scanning method usually involves the control shown in FIG. 2, in which case, the stage needs to reach a preset speed before inspection can be started. This method, therefore, requires extra regions and time for acceleration and deceleration of the stage, as shown in FIG. 3, and reduction in inspection time depends upon reduction of these acceleration and deceleration sections.

### Means for Solving the Problem

In order to solve the above problem, a first aspect of the present invention includes: scanning means that mounts a sample thereupon and moves in at least one direction with the mounted sample; means that illuminates the sample; imaging means that forms an optical image of the sample illuminated by the illumination means; detection means that includes a detector to detect the optical image formed by the imaging means, the detector further converting the optical image into a signal; defect detection means that detects defects on the sample by processing the signal detected by the detection means; means that reviews a location detected by the defect detection means; and means that displays a result obtained by the reviewing means, wherein the detector has its operational speed controlled according to a particular speed of the scanning means.

In order to solve the above problem, a control item relating to the detector is an accumulation time of the detector.

In order to solve the above problem, the control of the detector in the first aspect of the present invention is performed during the acceleration/deceleration of the scanning means.

In order to solve the above problem, a second aspect of the present invention includes: scanning means that mounts a sample thereupon and moves in at least one direction with the mounted sample; means that illuminates the sample; imaging means that forms an optical image of the sample illuminated by the illumination means; detection means that detects the optical image formed by the imaging means, and then converts the optical image into an image; defect detection means that detects defects on the sample by processing the image detected by the detection means; means that reviews a location detected by the defect detection means; means that displays a result obtained by the reviewing means; and means that measures a position or speed of the scanning means, wherein the image is corrected according to information acquired by the measuring means.

In order to solve the above problem, the measuring means further measures speed or position deviations from an acceleration level of the scanning means.

In order to solve the above problem, a third aspect of the present invention includes: scanning means that mounts a sample thereupon and moves in at least one direction with the mounted sample; means that illuminates the sample; imaging means that forms an optical image of the sample illuminated by the illumination means; detection means that detects the optical image formed by the imaging means, and then converts the optical image into an image; defect detection means that detects defects on the sample by processing the image detected by the detection means; means that reviews a location detected by the defect detection means; and means that displays a result obtained by the reviewing means, wherein the result display means selectively displays the images acquired during imaging of the sample at fixed time intervals.

In order to solve the above problem, a fourth aspect of the present invention includes: scanning means that mounts a sample thereupon and moves in at least one direction with the mounted sample; means that illuminates the sample; imaging means that forms an optical image of the sample illuminated by the illumination means; detection means that detects the optical image formed by the imaging means, and then converts the optical image into an image; means that calculates a rotational angle formed between the sample and a scanning direction of the scanning means, by processing the image detected by the detection means; defect detection means that detects defects on the sample using the image corresponding to a position shifted through the angle calculated by the angle calculation means; means that reviews a location detected by the defect detection means; and means that displays a result obtained by the reviewing means.

In order to solve the above problem, a fifth aspect of the present invention includes: the step of scanning a sample by moving in at least one direction after mounting the sample; the step of illuminating the sample; the step of forming an optical image of the sample illuminated in the illumination step; the step of detecting the optical image formed in the image forming step, and then converting the optical image into a signal; the step of detecting defects on the sample by processing the signal detected in the detection step; the step of reviewing a location detected in the defect detection step; and the step of displaying a result obtained in the reviewing step, wherein a detector used in the detection step has its operational speed controlled according to a particular speed in the scanning step.

In order to solve the above problem, the fifth aspect of the present invention further includes controlling an accumulation time of the detector as a control item relating to the detector.

In order to solve the above problem, the control of the detector is performed during the acceleration/deceleration in the scanning step.

In order to solve the above problem, a sixth aspect of the present invention includes: the step of scanning a sample by moving in at least one direction after mounting the sample; the step of illuminating the sample; the step of forming an optical image of the sample illuminated in the illumination step; the step of detecting the optical image formed in the image forming step, and then converting the optical image into an image; the step of detecting defects on the sample by processing the image detected in the detection step; the step of reviewing a location detected in the defect detection step; the step of displaying a result obtained in the reviewing step; and the step of measuring a position or speed in the scanning step, wherein the detected image is corrected according to information obtained in the measuring step.

In order to solve the above problem, the measuring step takes place to measure speed or position deviations from an acceleration level obtained in the scanning step.

In order to solve the above problem, a seventh aspect of the present invention includes: the step of scanning a sample by moving in at least one direction after mounting the sample; the step of illuminating the sample; the step of forming an optical image of the sample illuminated in the illumination step; the step of detecting the optical image formed in the image forming step, and then converting the optical image into an image; the step of detecting defects on the sample by processing the image detected in the detection step; the step of reviewing a location detected in the defect detection step; and the step of displaying a result obtained in the reviewing step, wherein the result display step takes place to selectively display the images acquired during imaging of the sample at fixed time intervals.

In order to solve the above problem, an eighth aspect of the present invention includes: the step of scanning a sample by moving in at least one direction after mounting the sample; the step of illuminating the sample; the step of forming an optical image of the sample illuminated in the illumination step; the step of detecting the optical image formed in the image forming step, and then converting the optical image into an image; the step of calculating a rotational angle formed between the sample and a scanning direction in the scanning step, by processing the image detected in the detection step; the step of detecting detects on the sample using the image corresponding to a position shifted through the angle calculated in the angle calculation step; the step of reviewing a location detected in the defect detection step; and the step of displaying a result obtained in the reviewing step.

### Effects of the Invention

The present invention provides inspection faster than that executable using conventional technology.

### BRIEF DESCRIPTION OF THE DRAWINGS

FIG. 1 is a diagram illustrating an embodiment of the present invention;

FIG. 2 is a diagram illustrating an operation time and speed of a stage;

FIG. 3 is a diagram illustrating a traveling route and accelerating/decelerating regions of the stage;

FIG. 4 is a diagram illustrating a relationship between a defect size and the amount of light scattered;

FIG. 5 is a diagram illustrating a control situation relating to an information accumulation time of a detector;

FIG. 6 is a diagram that illustrates a display screen appearing during inspection;

FIG. 7 is a diagram illustrating an example of a reviewing screen;

FIG. 8 is a diagram illustrating a sequence of image display on the reviewing screen;

FIG. 9 is a diagram illustrating an example of image display;

FIG. 10 is a diagram illustrating another example of image display;

FIG. 11 is a diagram illustrating a configuration for detecting a position of a transport system;

FIG. 12 is a diagram illustrating a process flow of image correction;

FIG. 13 is a diagram that illustrates differences between images obtained at different speeds of the stage;

FIG. 14 is a diagram illustrating another configuration for detecting the position of the transport system;

FIG. 15 is a diagram illustrating another example of a reviewing screen;

FIG. 16 is a diagram illustrating a method of extracting a defective section;

FIG. 17 is a diagram illustrating a method of converting monochrome display into color display;

FIG. 18 is a diagram illustrating another embodiment of the present invention;

FIG. 19 is a diagram that illustrates a display screen appearing for alignment;

FIG. 20 is a diagram illustrating an operations screen relating to changing an image acquisition position;

FIG. 21 is a diagram illustrating yet another embodiment of the present invention; and

FIG. 22 is a diagram illustrating a method of extracting an image.

### MODE FOR CARRYING OUT THE INVENTION

Hereunder, embodiments of the present invention will be described using the accompanying drawings.

### First Embodiment

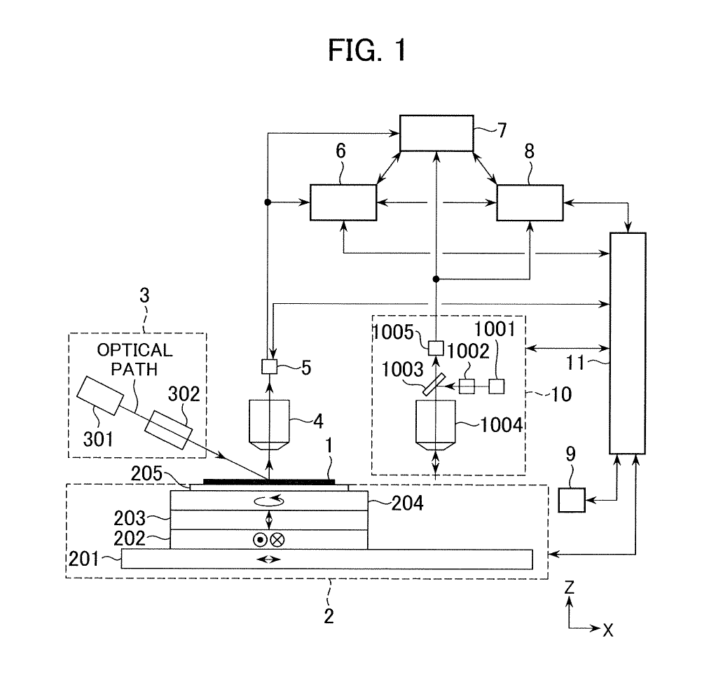

An embodiment of an apparatus for inspecting pattern defects according to the present invention is shown in FIG. 1. The pattern defect inspecting apparatus of the invention includes a transport system 2 for mounting a wafer 1 as an object to be inspected, and moving the wafer 1. This apparatus also includes an illumination device 3, an objective lens 4, a detection unit 5, a signal-processing unit 6, an automatic defect classification (ADC) unit 7, an input/output unit 8, a transport information hold unit 9, an optical reviewing system 10, a controller 11 for various constituent elements of the apparatus, and a relay lens and mirror not shown. Arrows connecting from the controller 11 to the various constituent elements, although part of the arrows is not shown, indicate that control signals and the like are transmitted and received during communication.

Operation is next described below. Illumination light that has been emitted from the illumination device 3 reaches the wafer 1. The light scattered from circuit patterns or defects on the wafer 1 is converged by the objective lens 4, and the converged light is converted into an image signal by photoelectric conversion in the detection unit 5. The image signal is transmitted to the signal-processing unit 6 and the ADC unit 7. The signal-processing unit 6 provides the received image signal with a defect detection process and detects defects on the wafer 1. Detection results are transmitted to the ADC unit 7 and the input/output unit 8. The signal that has been transmitted to the ADC unit 7, in contrast, is provided with a defect classification process, results of which are then sent to the input/output unit 8. The apparatus inspects an entire surface of the wafer 1 by conducting the above sequence while moving the wafer 1 using the transport system 2. During the inspection, speed information on the transport system 2 is acquired by the transport information hold unit 9 and then used for control of the detection unit 5 and the signal-processing unit 6. A location that has been detected during the above process is reviewed by the optical reviewing system 10 and determined whether the defect is a real (actual) defect or a false one.

Details of each element are described below.

The transport system 2 is first detailed below. The transport system 2 includes an X-axis stage 201, a Y-axis stage 202, a Z-axis stage 203, a θ-axis stage 204, and a wafer chuck 205. The X-axis stage 201 is constructed so as to be able to travel at constant speed, and the Y-axis stage 202 is constructed so as to be able to move stepwise. The X-axis stage 201 and the Y-axis stage 202 can be used to move all locations of the wafer 1 to a position directly under central axes of the objective lens 4 and the optical reviewing system 10. The Z-axis stage 203 has a function that moves the wafer chuck 205 vertically. The Z-axis stage 203 also has a function that moves the wafer 1 to an on-object focal position of the objective lens 4 and the optical reviewing system 10 in accordance with a signal from an auto-focusing mechanism not shown. In addition, the θ-axis stage 204 rotates the wafer chuck 205 and has a rotating function for matching a traveling direction of the X-axis stage 201 and the Y-axis stage 202 and a rotational direction of the wafer 1. Furthermore, the wafer chuck 205 has a function that immobilizes the wafer 1 by vacuum chucking or attraction.

The illumination device 3 shapes the illumination light with which to irradiate the wafer 1. The illumination device 3 includes an illumination light source 301 and illumination optics 302. The illumination light source 301 is a laser light source or a lamp light source. The laser light source, because of its ability to shape illumination light of high luminance, can also increase the amount of light scattered from a defect, and is therefore effective for high-speed inspection. The lamp light source, in contrast, is low in coherence of light and thus has an advantage of a significant reduction effect against speckle noise. The laser light source can use wavelength bands of visible light, ultraviolet light, deep ultraviolet light, vacuum ultraviolet light, extreme ultraviolet light, or the like, and can also employ continuous oscillation or pulse oscillation as a lasing form. The light source desirably has a wavelength of nearly 550 nm or less. More specifically, this wavelength can be, for example, 532 nm, 355 nm, 266 nm, 248 nm, 200 nm, 193 nm, 157 nm, or 13 nm.

The laser light source can be made of a second harmonic generation (SHG) type, third harmonic generation (THG) type, or fourth harmonic generation (FHG) type that generates second, third, or fourth harmonic signals of fundamental waves by converting solid-state YAG laser light of a 1024-nm wavelength into light of a different wavelength using a nonlinear optical crystal. Alternatively, the laser light source can be an excimer laser or an ion laser. Further alternatively, the laser light source can be of a type that resonates two kinds of light different in wavelength and oscillates light of a third wavelength. This method is used to output laser light of a 199-nm wavelength by sum frequency resonance of SHG wave of 488-nm wavelength argon (Ar) laser light and 1064-nm YAG laser light. If a pulse oscillation laser is to be used, it can be a low-frequency pulse oscillation laser whose oscillation frequency is as low as several hertz, or a semi-continuous oscillation pulse laser of several tens of hertz to several hundreds of megahertz. Additionally, the pulse oscillation method used may be Q-switched or mode-locked.

Advantages of various light sources are discussed below. First, using a light source of a short wavelength improves resolution of the optical system and is thus expected to implement highly sensitive inspection. Use of a solid-state laser such as the YAG type allows a small-scale apparatus to be realized at a low cost since no large-scale related equipment is required. Use of a high-frequency pulse oscillation laser also allows realization of an inexpensive apparatus since the laser can be handled equivalently to a high-output continuous oscillation laser and hence since inexpensive optical components can be used that are low in transmittance and reflectance. Lasers of a short pulse duration are advantageous in that their small coherence length makes it easy to reduce coherence with time by adding a plurality of kinds of illumination light each different in optical length.

A lamp that emits light of a wavelength region equivalent to that of a laser light source can be used as a lamp light source. The lamp light source, if it outputs a desired wavelength, can be either a Xe lamp, a Hg—Xe lamp, a Hg lamp, a high-pressure Hg lamp, an extra-high-pressure Hg lamp, an electron-beam gas emission lamp (having an output wavelength of, say, 351 nm, 248 nm, 193 nm, 172 nm, 157 nm, 147 nm, 126 nm, or 121 nm), or the like. A lamp that generates higher output at the desired wavelength is desirable, and a lamp of a shorter arc is further desirable. This is because illumination light can be formed more easily. The illumination optics 302 is an optical system functioning to expand a beam size of the light emitted from the illumination light source 301, and converge the light. The illumination optics 302 may have an added quantity-of-light control function and/or illumination light coherence reduction function as required.

The objective lens 4 has a function that converges the light scattered from a region illuminated by the illumination device 3 and forms an image upon an image acquisition surface of the detection unit 5. The objective lens 4 desirably has its aberration corrected for in a wavelength region of the illumination device 3. In terms of structure, the lens may be a dioptric lens or a reflective lens constructed of a reflecting plate having a curvature.

The detection unit 5 has a function that conducts photoelectric conversion of the light converged by the objective lens 4, and the detection unit 5 is constructed so as to allow control of an imaging time or an operational speed. The detection unit 5 is, for example, an image sensor. This image sensor can be either a one-dimensional CCD sensor or TDI (Time Delay Integration) image sensor, or such a two-dimensional CCD sensor as used in a TV camera, or a high-sensitivity camera such as an EB-CCD camera. A further possible alternative is a sensor whose detection elements of CCD are divided into a plurality of TAP's to achieve rapid detection, or a sensor with an anti-blooming function, or a surface-irradiation type of sensor that provides irradiation from a covering glass surface of CCD, or a back-irradiation type of sensor that conducts irradiation from a surface opposite to the covering glass surface of CCD. The back-irradiation type is desirable for a wavelength shorter than that of ultraviolet light.

For a less expensive inspecting apparatus configuration, using a TV camera or a CCD linear sensor is desirable as a method of selecting a detector to be used for the detection unit 5. Using a TDI image sensor or an EB-CCD camera is preferable for detecting very weak light. One advantage of TDI image sensors is that adding a detected signal a plurality of times allows this signal to be improved in signal noise ratio (SNR). A detector of tap composition is desirable where rapid operation is required, or a detector with anti-blooming function is desirable where the light that the detection unit 5 receives is of a high dynamic range, that is, where the light that saturates the photoelectric conversion section of the detector enters the detection unit 5. The signal-processing unit 6 includes an image storage section, having a function that extracts defect candidates from the signal obtained by the detection unit 5. The method described in JP-2006-029881-A suffices as a method to be used to extract the defect candidates.

The ADC unit 7 has a function that uses the detected signal to classify detected objects according to a kind. Operation is described below. The signal that has been obtained by the detection unit 5 is transmitted to the signal-processing unit 6 and the ADC unit 7. The signal-processing unit 6 conducts the defect detection process and then if a defect is determined to be present, transmits to the ADC unit 7 a defect detection flag and feature quantities, the latter of which having been calculated by the signal-processing unit 6. The feature quantities are, for example, a sum of signal values of the defective portion, differential values of the signal values, the number of pixels, projection length, gravitational positions, and a signal value of a nondefective portion compared with the defective portion. The feature quantities associated with positions are a distance from a center of the wafer 1, a die-by-die repetition count of the wafer 1, a position in the die, and more. Upon receiving the defect detection flag, the ADC unit 7 identifies the kind of defect from the image obtained by the detection unit 5 or the signal-processing unit 6, or from the feature quantities. Classification is by mapping several kinds of feature quantities upon multi-dimensional coordinate axes and dividing the mappings into regions with a preset threshold level. The kinds of data defects present in each region are preset, whereby the kinds of defects in the region are determined. More specifically, it suffices just to use the method described in JP-2004-093252-A using FIG. 26 and others.

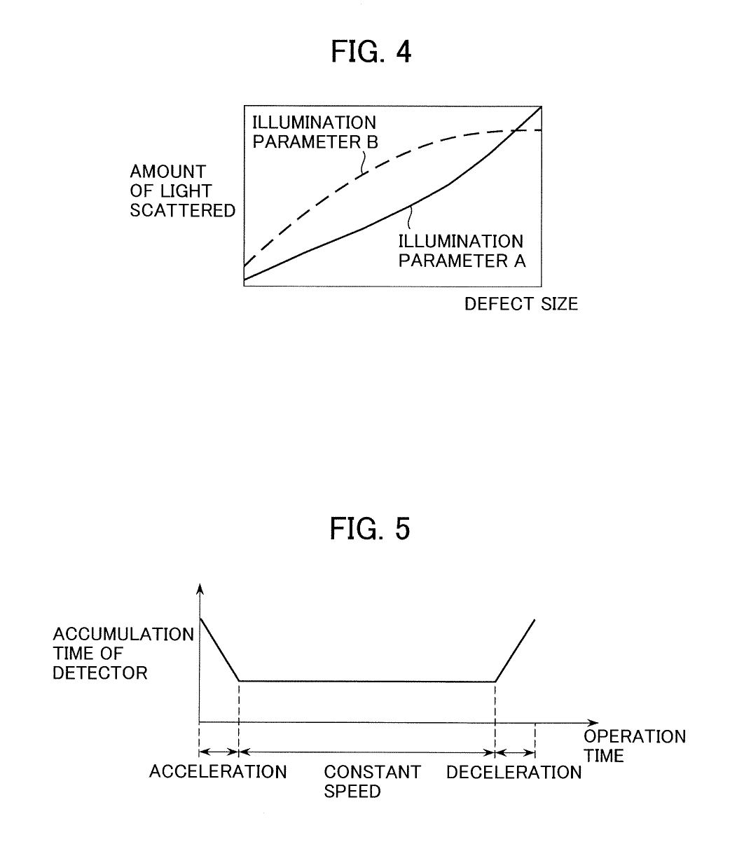

Defect size calculation with the ADC unit 7 can be conducted by converting a signal quantity of the defective portion into a defect size on the basis of the image information obtained from the defective portion. More specifically, it suffices just to use the method described in JP-2003-098111-A using FIG. 15 and others. Parameters concerning the illumination device 3 are desirably selected for improved calculation accuracy of the defect size. For example, the defect size and the amount of light scattered from the defect vary with an angle of the illumination and a polarizing direction, as schematically shown in FIG. 4. An optical parameter suitable for calculating the defect size is such that the defect size and the amount of light scattered will be in positive proportion. Since defect detection performance changes according to particular optical parameters, however, the parameters relating to the illumination device 3 are desirably determined considering defect detection performance and defect size calculation accuracy. Roughly speaking, a desirable angle of illumination is a lower elevation and a desirable polarizing direction is somewhere in between S-polarizing and P-polarizing.

The kinds of defects that have been determined using any one of the methods described above are transmitted as classification information to the input/output unit 8 and then displayed as defect information.

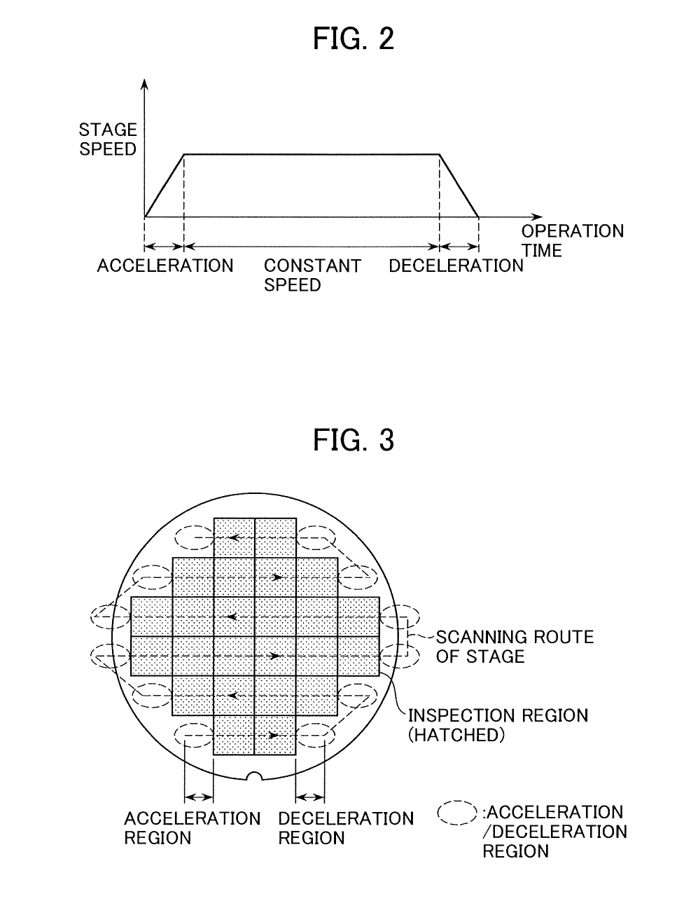

The transport information hold unit 9 holds the speed or position information relating to the transport system 2. The speed information here relates to a relationship between the operation time and speed of the transport system 2, this relationship being shown in FIG. 2, for example. The speed information may be determined from the control information sent to the transport system 2, or may be measured by actually driving the transport system 2. The speed information is sent to the controller 11, in which an information accumulation time of the detector in the detection unit 5 is then controlled as shown in FIG. 5. This control provides a constant pixel size on the wafer 1 during acceleration and deceleration of the transport system 2. During the acceleration of the transport system 2, since the transport system 2 is low in scanning speed, the information accumulation time of the detector is extended, and once the scanning speed has become constant, the accumulation time is also kept constant. In this way, images are acquired. During deceleration, the accumulation time is extended once again. Changing the accumulation time in this manner according to the particular speed of the transport system 2 allows the process in the signal-processing unit 6 to be simplified since the pixel size on the wafer 1 remains unchanged during acceleration and deceleration. During the simplification of the process, brightness of each image changes according to particular length of the accumulation time, and if this poses a problem, the changes in the brightness of the image can be normalized by dividing this brightness level by the accumulation time consumed during image acquisition.

The optical reviewing system 10 is used to review the location that the signal-processing unit 6 detected. The optical reviewing system 10 includes an illumination light source 1001, illumination optics 1002, a beam splitter 1003, an objective lens 1004, and a detection unit 1005. During operation of the optical reviewing system 10, light that has been emitted from the illumination light source 1001 is shaped by the illumination optics 1002, then reflected by the beam splitter 1003, and directed to the wafer 1 via the objective lens 1004. The light reflected or scattered from the wafer 1 is converged upon the objective lens 1004 and forms an image in a detector of the detection unit 1005. The illumination light source 1001 can be any of the useable light sources described as the illumination light source 301.

The illumination optics 1002 is desirably combined with the objective lens 1004 to provide the wafer 1 with Koehler illumination. The objective lens 1004 is desirably aberration-corrected to suit a wavelength of the illumination light source 1001. A two-dimensional TV camera or the like can be used as the detector of the detection unit 1005.

Design parameters for the optical reviewing system 10 are desirably such that they bring about higher resolving power than those of the optical inspection system (from the illumination light source 301 to the detection unit 5). That is, referring to the wavelength λ of the illumination light source 1001 and NA of the objective lens 1004, since a smaller value of λ/NA creates higher resolving power, values that satisfy (Expression 1) should be selected as λ and NA.

(λr/NAr)≦(λd/NAd) (Expression 1)

where

λr: principal wavelength of the illumination light source 1001,

NAr: NA of the objective lens 1004,

λd: principal wavelength of the illumination light source 301, and

NAd: NA of the objective lens 4.

While the above description has assumed an optical reviewing system of the brightfield type (illumination through an objective lens), the apparatus may use an optical reviewing system of the darkfield type (illumination from the outside of an objective lens). One advantage from using the brightfield type of optical system is that a user can obtain images in a visually familiar form, and an advantage from using the darkfield type of optical system is that the same image quality as achievable during inspection can be obtained. The number of wavelengths of the optical reviewing system can be different from that used in the optical inspection system. In other words, the optical inspection system can use laser light of a single wavelength and the optical reviewing system can use lamp light of multiple wavelengths. One advantage is that whether the section is a real (actual) defect or a false one can be easily identified by reviewing through an optical system different from that used for inspection. For example, when one section is reviewed using two different optical systems, if both systems form different images between the detection unit and a reference unit, the section is obviously identified as a defect. However, although there are differences in a state of the image created by the optical inspection system, if the differences are unclear on the image created by the optical reviewing system, that section is identified as a false defect. Identification is thus facilitated.

Next, the input/output unit 8 is described below. The input/output unit 8 acts as an interface unit with the user, and as an input/output unit for data and control information. Input information from the user includes, for example, layout information on the wafer 1, a name of a process, and parameters concerning the optical system mounted in the inspecting apparatus of the present invention. Output information to the user during inspection includes, for example, an inspection position, a stage speed, and the control information relating to the detection unit 5. Output information to the user after inspection includes, for example, inspection results, the kinds of defects, and images. Even during inspection, substantially the same display as made during an end of the inspection may be conducted for the inspected region. During the inspection, inspection results on the inspected region are displayed, which is advantageous in that before the inspection ends, the user can recognize a state of the object being inspected.

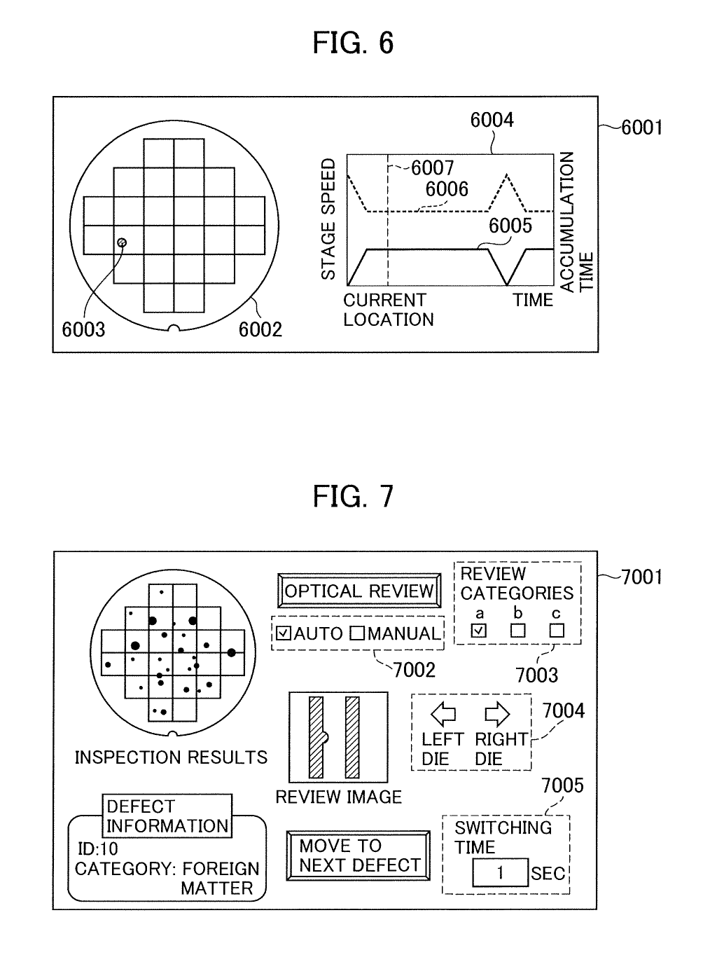

FIG. 6 shows an example of display during the inspection. A display screen 6001 includes a profile 6002 of the wafer which is the object to be inspected, an inspection position 6003, a control information display section 6004 displaying a stage speed and the control information, such as an accumulation time that relates to the detection unit 5, stage speed control information 6005, accumulation time control information 6006, and a current position 6007 indicating the location of the control information that corresponds to the inspection position 6003. The control information display section 6004 includes a horizontal axis indicating an elapsed time of the inspection or the inspection position of the wafer 1, and a vertical axis indicating the stage speed control information or the control information relating to the detection unit 5, such as the accumulation time.

During the inspection, since the display shown in FIG. 6 appears, display of the stage speed and the accumulation time enables the user to confirm whether the stage speed and the accumulation time are in a normal relationship. Although the control information display section 6004 may be displayed alone, the control information display section 6004 and the inspection position 6003 can be displayed together for a better understanding of the control state.

An example in which inspection results and an image of a detection region reviewed are displayed is shown in FIG. 7. A result display screen 7001 includes the inspection results indicating the detection locations within the wafer 1, defect information, an OPTICAL REVIEW button, an AUTO or MANUAL selector 7002, a review category selector 7003, a review image display section, a review position selector 7004, a MOVE TO NEXT DEFECT button, and a switching time display section 7005. However, not all of the buttons and display sections are necessary; it suffices if inspection results and an image to be reviewed are displayed as a minimum requirement.

The operation is described below. After the defect detection process described above, the result display screen 7001 is displayed. Whether locations of detection are to be reviewed in AUTO mode is selected first. That is, the AUTO button in the AUTO/MANUAL selector 7002 is selected if the review images corresponding to each location of detection are to be displayed at fixed time intervals. The MANUAL button is selected if the user is to select defects to be reviewed. One of categories in the review category selector 7003 is next selected if the kind of defect to be reviewed is to be limited. The displayed categories correspond to the defect kinds that have been identified by the ADC unit 7. Next after the selection of the category, a screen switching time for the review images is input to the switching time display section 7005. The screen switching time is not the fixed time mentioned as to the AUTO/MANUAL selector 7002; it is a switching time for alternate display between the image of the detection region and an image of a reference region, the review image and the reference image being described later herein.

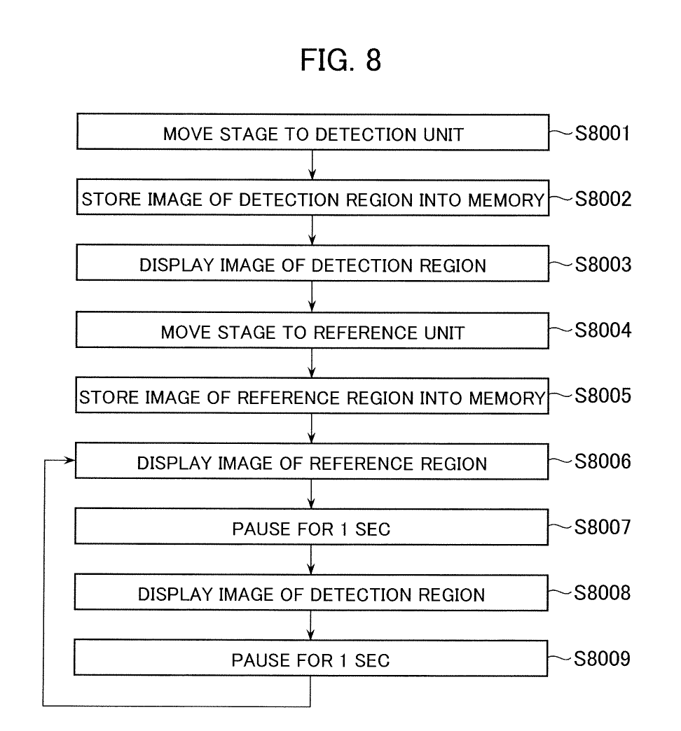

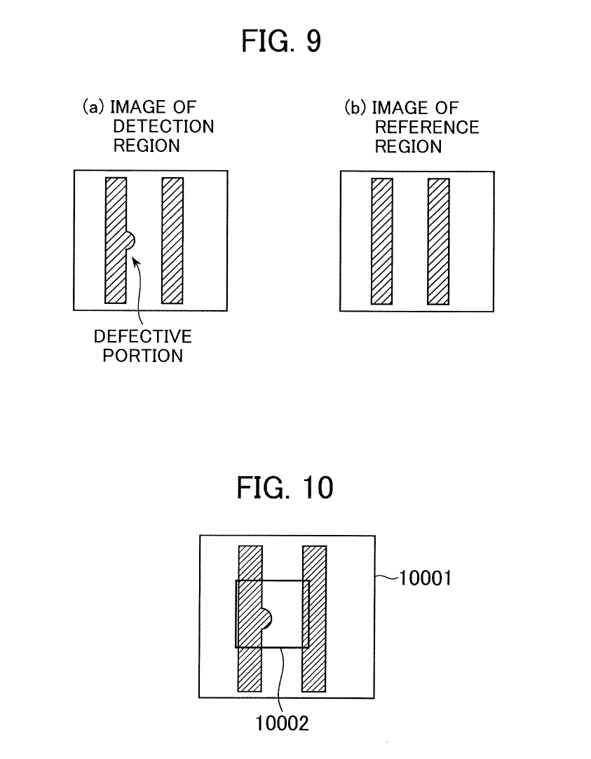

After the above setup operations, selection of the detection region on the inspection results or a press of OPTICAL REVIEW button displays the image of the detection region in the review image display section. FIG. 8 shows a process sequence in which the image is displayed. First, the apparatus moves the stage of the transport system 2 to the detection region (step S8001) and after storing the image of the detection region into a memory (step S8002), displays the image of the detection region on the review image display section (step S8003). Next, the apparatus moves the stage of the transport system 2 to the reference region (step S8004). More specifically, the stage is moved to an adjacent die or a place in which the same circuit pattern as on the detection region is present. After that, the apparatus stores the image of the reference region into the memory (step S8005) and displays the image of the reference region on the review image display section (step S8006). After about one second of pause (=time value displayed in the switching time display section 7005) with the image of the reference region remaining on the display (step S8007), the image of the detection region is displayed once again (step S8008), followed by another one second of pause (=time value displayed in the switching time display section 7005) (step S8009). After this, control is returned to step S8006, in which step the display switching of the images is continued. The images shown at this time will be such images of the detection region and reference region that are shown as (a) and (b) in FIG. 9. Since both images are displayed in alternate form, an afterimage effect of the human eye enables the user to rapidly recognize any differences between the image of the detection region and that of the reference region.

On the image displayed in the review image display section, the detection region may be explicitly displayed using a region 10002 smaller than an overall image frame 10001, as shown in FIG. 10. This display will enable the user to simultaneously recognize the detection region and the circuit pattern around the detection region, and hence to readily understand what kind of circuit pattern composition exists in the detection location.

The display of inspection results shown in FIG. 7, is an example with defect positions plotted in different dot sizes for each kind of defect. Although these defect kinds correspond to those identified by the ADC unit 7, information that has been classified into defect categories such as foreign substances, pattern defects, and scratches, may be used or information based on classification according to defect size may be used. The use of the information based on classification according to defect category has an advantage in that the user can estimate in which process apparatus the defective product is occurring. The use of the information based on classification according to defect size has an advantage in that the user can estimate criticality of the defect. Of course, both types of information may be used.

Adopting the apparatus configuration described above makes it possible to reduce the inspection time and the reviewing time of the detection unit.

### Second Embodiment

Another embodiment relating to image correction with respect to the speed of the transport system 2 is described below. The foregoing embodiment has been applied to prior acquisition of the speed information relating to the transport system 2. The present embodiment, however, concerns a configuration in which, even if the transport system 2 changes in speed, the apparatus can inspect pattern defects by acquiring the scanning position or speed information relating to the transport system 2, and conducting image corrections with the signal-processing unit 6. The present embodiment has an advantage that even if the transport system 2 abruptly vibrates, the apparatus can follow up the vibration.

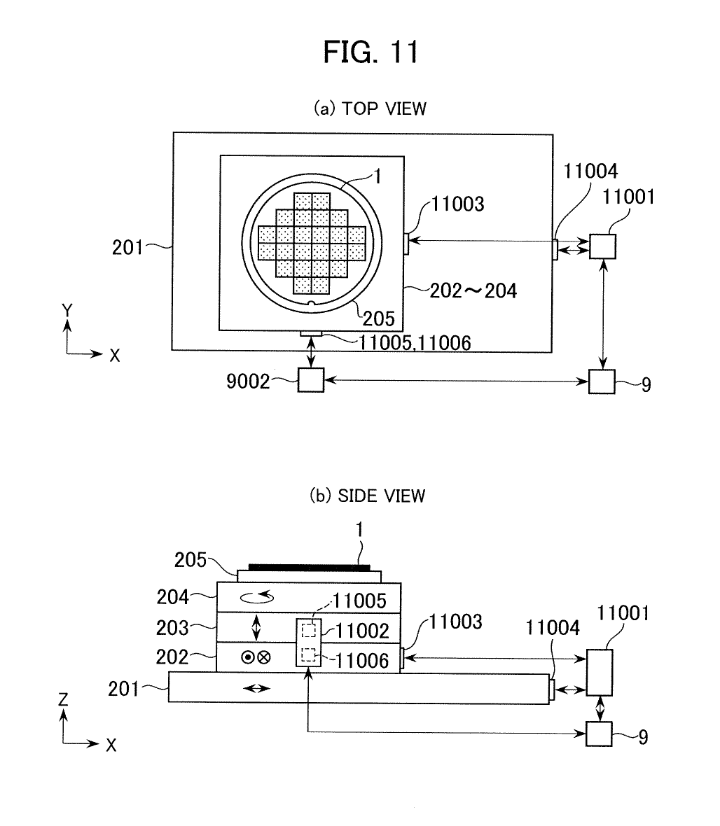

FIG. 11 shows the apparatus configuration. FIG. 11(a) is a top view of the apparatus, and FIG. 11(b) is a side view thereof. Referring to FIG. 11, the apparatus includes critical laser-measuring units 11001 and 11002, and critical measuring mirrors 11003 to 11006, in addition to the transport system 2 and the transport information hold unit 9. In this configuration, the apparatus emits critical measuring laser light from the critical laser-measuring unit 11001, and after receiving the laser light reflected from the critical measuring mirrors 11003 and 11004, detects a position of the X-axis stage 201 from a phase difference of the reflected laser light. During emission from the critical laser-measuring unit 11002, the apparatus similarly detects a position of the Y-axis stage 202 from the light reflections from the critical measuring mirrors 11005 and 11006. Position information that has been obtained by the critical laser-measuring units 11001 and 11002 is transmitted to the transport information hold unit 9.

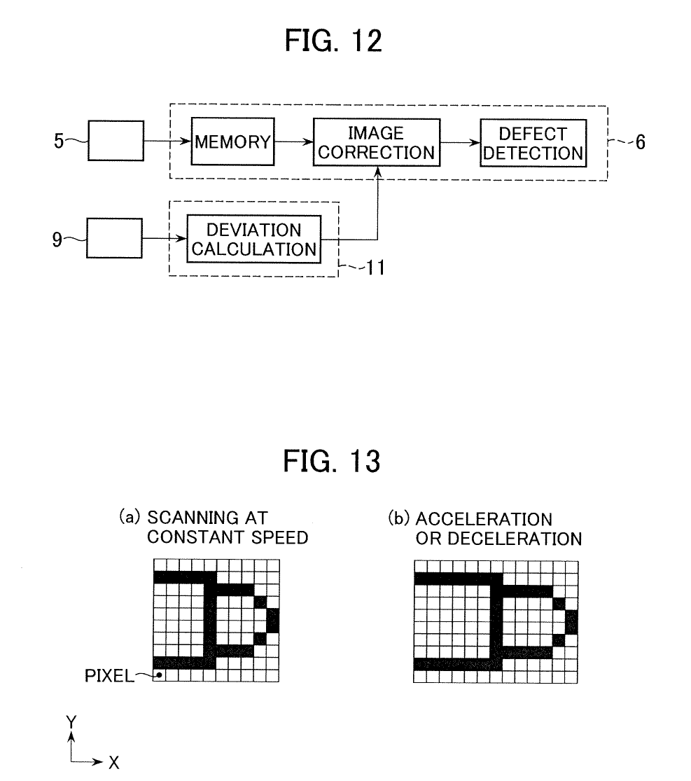

Process flow is described below using FIG. 12. In the present embodiment, the detection unit 5 is driven with a constant accumulation time or at a constant operational speed. An image that the detection unit 5 has acquired is saved in an image memory of the signal-processing unit 6. The image acquired during scanning at the constant speed usually looks like image (a) shown in FIG. 13, whereas an image acquired during nonconstant scanning is distorted, as with image (b) shown in FIG. 13. Image (b) in FIG. 13 is unusually elongated in a horizontal direction since the scanning speed of the transport system 2 decreases during acceleration and deceleration. The position information that the transport information hold unit 9 has obtained is transmitted to the controller 11 for calculation of a deviation from the inspection position corresponding to scanning at the constant speed. The position deviation information is next used to correct the horizontally elongated image and approximate this image to image (a) shown in FIG. 13. The correction can be conducted by merging signal values of several pixels arranged in an X-direction of the elongated image, or by performing additions and/or subtractions with respect to signal values of adjacent pixels at a ratio less than one pixel, that is, at a sub-pixel level. The image correction process can be conducted with the signal-processing unit 6, and the corrected image may be transmitted to the ADC unit 7.

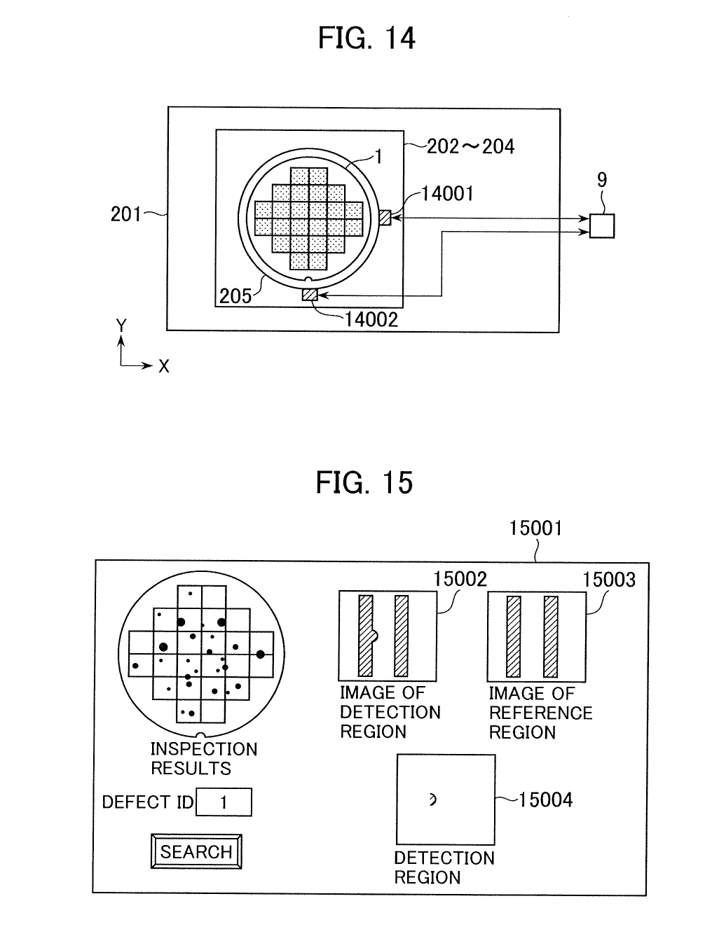

An example of measuring the position of the transport system 2 has been described above. However, the transport system 2 itself may include mounted accelerometers. For example, as shown in FIG. 14, accelerometers 14001 and 14002 may be installed on the wafer chuck 205. The accelerometer 14001 may measure an acceleration level of the X-axis stage 201 and transmits the measured value to the transport information hold unit 9. The accelerometer 14002 may measure an acceleration level of the Y-axis stage 202 and transmits the measured value to the transport information hold unit 9. The controller 11 may then use the acceleration level information to calculate a speed or position deviation of the transport system 2, and the above-described image correction may be done using calculation results.

The correction relating to pixels arranged in the X-direction has also been described above, but since X-axial and Y-axial position coordinates or speeds or acceleration levels are measurable, these data measurements may be used to conduct both X- and Y-axial corrections. The X- and Y-axial corrections are advantageous in that correction accuracy improves, and hence, that defect detection performance improves.

### Third Embodiment

FIG. 15 shows another example of a result display screen. The result display screen 15001 of FIG. 15 includes inspection results that indicate the detection locations within the wafer 1, a defect ID display section, a SEARCH button, an image 15002 of the detection region, an image 15003 of the reference region, and an image 15004 extracted from the detection region.

Operation is described below. After the above-described defect detection, the result display screen 15001 is displayed. A press of the SEARCH button displays a defect ID in the defect ID display section, displaying the images 15002 to 15004 on the screen. The reference region here, as with the above, is the place in which is present an adjacent die or the same circuit pattern as on the detection region.

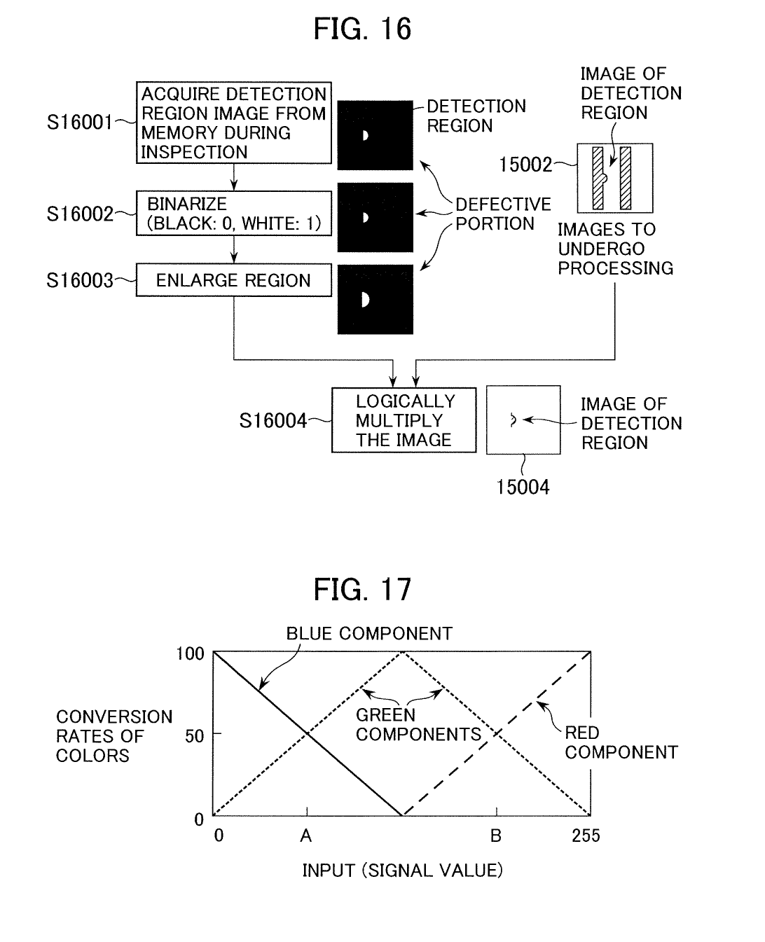

An example of a sequence of creating the image 15004 extracted from the detection region is described below using FIG. 16. First, the image of the detection region that has been created during the defect detection process is acquired from the image memory of the signal-processing unit 6 (step S16001). The acquired image is converted into binary form (step S16002). In this step, “1” and “0” are desirably assigned to the detection region and other regions, respectively. Next, the detection region is enlarged (step S14003). More specifically, the detection region is dimensionally extended through one to several pixels of space in each direction of the image. A logical product of the image 15002 of the detection region and the image having the dimensionally extended detection region is calculated (step S16004). Thus, only the portion of “1” remains in the detection region, so that only the detected portion of the image 15002 of the detection region can be extracted.

While the images of the detection region and reference region, shown in FIGS. 7 and 15, have been described above as the images acquired by the optical reviewing system 10, images that were used for the inspection may be used instead as the images of the detection region and reference region. In that case, since image re-acquisition is unnecessary, there is an advantage that the reviewing time can be further reduced. After the inspection of the image to be reviewed, the optical system for the inspection, not the optical reviewing system 10, may also be used for acquiring images by moving the transport system 2 once again. This yields an advantage of cost reduction because of the optical reviewing system 10 not being used. Referring to image usage, the images acquired during inspection or by the optical reviewing system may be used as they are, or computation results on average values of a plurality of reference region images acquired from a plurality of neighboring dies may be used. Otherwise, a central value of the plurality of reference region images may be used. For example, if five images are used, when the pixels of each image are arranged in normal ascending order of luminance, the luminance ranked third in the array is selected. Using the plurality of images brings about an advantage in that such a subtle difference as to be of a level not equivalent to a defect in the images of the reference region can be excluded. In addition, using the central value offers advantages that even if the plurality of reference region images contain defective images, only when the number of defective images is 1 or 2, is it possible to remove information corresponding to the defective portions, and thus that images of the reference region that are not affected by the defective portions can be obtained.

Furthermore, if the illumination light source 1001 of the optical reviewing system 10 uses a laser of a single wavelength, since the image acquired by the detection unit 1005 contains no color information, a pseudo-color display may be made by conducting such grayscale conversions as in FIG. 17. In FIG. 17, a horizontal axis denotes an output level of the detection unit 1005 (i.e., an input level of the signal-processing unit 6) and a vertical axis denotes rates of conversion into three color components (the primary colors, namely, blue, green, and red). FIG. 17 uses 0 to 255 grayscale levels of eight-bit input data, with the rates of each color component being represented as 0 to 100. For example, if the input is data A, the color component is converted into a grayscale level obtained by mixing 50 kinds of blue and green each, and if the input is data B, the color component is converted into a grayscale level obtained by mixing 50 kinds of green and red each. One advantage from making the pseudo-color display is that visibility of the image improves even during the use of the laser light.

Furthermore, the optical reviewing system 10 may apply polarization control to impart high contrast to the images of the detection region and reference region. The polarization control here is a method in which a polarized state of the illumination light is adjusted for linearly polarized light or elliptically polarized light and then the light reflected/scattered from the wafer 1 is detected before the light enters the detection unit 1005. One advantage from applying the polarization control is that optical contrast can be improved.

### Fourth Embodiment

A further embodiment for reducing a defect inspection time and a reviewing time of the detection unit is described below. The present embodiment relates to reducing a precise alignment adjusting time of the wafer 1 for reduced inspection time. Precise alignment adjusting is an operation conducted to rotate the θ-stage 204 so that an angle of an arrangement direction of dies on the wafer 1 and an angle of a scanning direction of the X-stage 201 stay within a defined value (say, 1/1,000 degrees). Hereinafter, the two angles are referred to collectively as the rotational angle of the wafer. The precise alignment adjusting operation in related conventional technology involves calculating the rotational angle of the wafer by comparing the positions of the same circuit patterns on the dies at both left and right edges of the wafer 1 using a single optical system. Performing the precise alignment adjusting operation, therefore, requires a scanning time, the time for moving the transport system 2 to the left and right edges. The present embodiment reduces an inspection time by saving the scanning time.

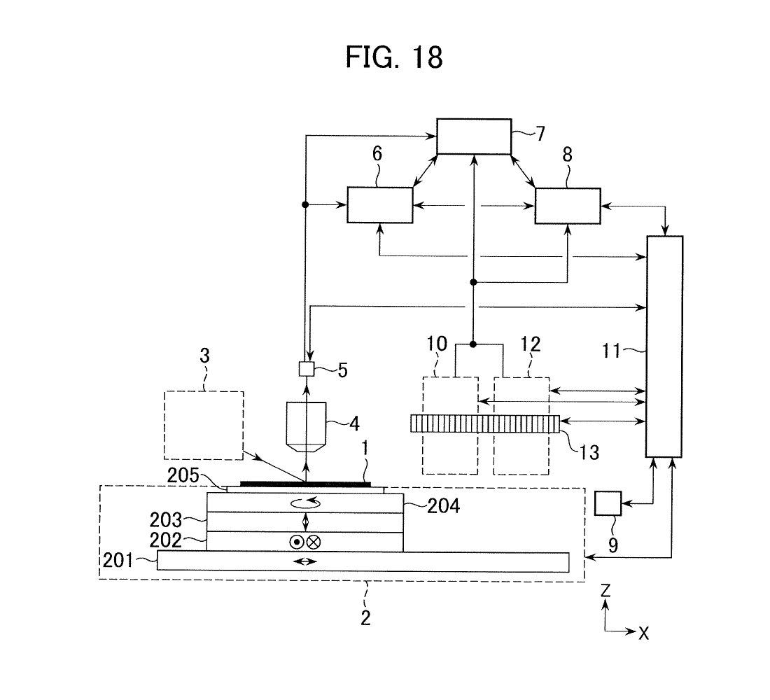

Details are described below using FIG. 18. An inspection apparatus of the present embodiment includes an optical reviewing system 12 and a shifter 13 for the optical reviewing system, in addition to the apparatus components shown in FIG. 1. The optical reviewing system 12 here is of the same specifications as those of the optical reviewing system 10, and the shifter 13 has a function that changes a distance between the optical reviewing systems 10 and 12.

Operation is described below. In the operation, the distance between the optical reviewing systems 10 and 12 is first adjusted using the shifter 13 to ensure that the distance is equal to an integral multiple of the die size on the wafer 1. Next, the wafer 1 is moved to a position directly under the optical reviewing systems 10, 12. At this time, since the optical reviewing systems 10, 12 have been adjusted to obtain the above distance, the same circuit patterns formed in the die region enter a field of the optical reviewing systems. If the rotational angle of the wafer is calculated from images obtained by the optical reviewing systems 10, 12, the rotational angle value of the wafer can be obtained without scanning with the X-stage 201. Thus, a precise alignment adjusting time can be reduced. The rotational angle of the wafer can be calculated using the same method as that used for the conventional precise alignment adjusting operation.

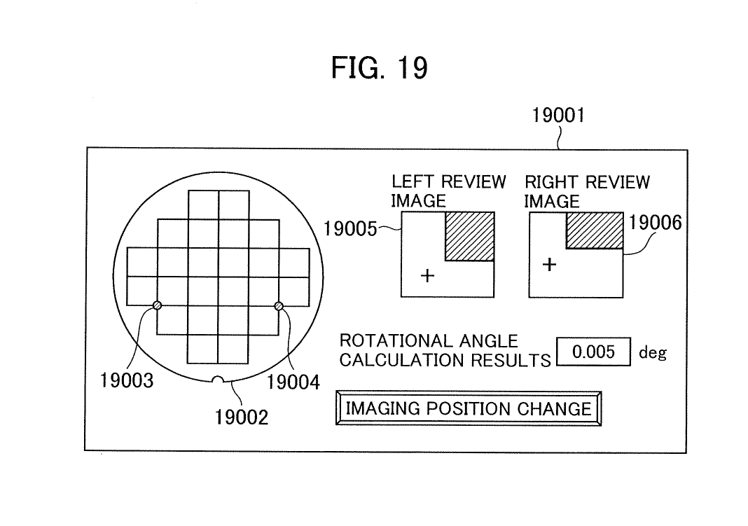

An example of display during the alignment operation in the present embodiment is shown in FIG. 19. A display screen 19001 includes a profile 19002 of the wafer which is the object to be inspected, an image acquisition position 19003 of the optical reviewing system 10, an image acquisition position 19004 of the optical reviewing system 12, an image 19005 acquired at the image acquisition position 19003, an image 19006 acquired at the image acquisition position 19004, a rotational angle calculation result display section, and reviewing position changing buttons.

One feature of the apparatus is that the images that the optical reviewing systems 10, 12 have acquired can be displayed at the same time during alignment. Although the present embodiment is described assuming that the images were obtained at the image acquisition positions 19003, 19004, if the alignment position is to be changed, the image acquisition positions can each be changed by pressing an image acquisition position changing buttons.

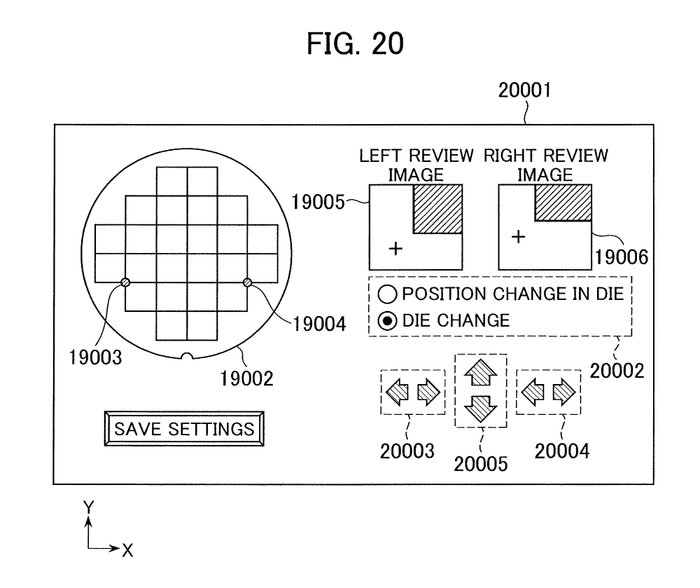

An example of an operating screen displayed after the image acquisition position changing buttons have been pressed is shown in FIG. 20. In addition to the display screen elements 19002 to 19006 shown in FIG. 19, the operating screen 20001 includes a moving parameter selector 20002 for selecting whether the imaging position is to be changed within the die, that is, the pattern to be aligned is to be changed, or whether the position of the die itself is to be changed. The operating screen 20001 also includes X-position changing buttons 20003, 20004 for moving the image acquisition position 19003 or 19004 in an X-direction, Y-position changing button 20005 for moving the image acquisition positions 18003 and 19004 in a Y-direction, and a settings saving button.

A pattern of higher image contrast is desirably selected to change the imaging position. In addition, the distance from one imaging position to another is desirably set to be longer. These settings improve calculation accuracy.

The inspection operation that follows completion of the precise alignment adjusting operations described above is the same as in the first embodiment.

In the first embodiment, the images of the detection region and reference region have been acquired by scanning with the transport system 2 during the reviewing operation of the detection region after the inspection. In the present embodiment, however, as described above, since images of dies distant by one to several tens of dies can be simultaneously acquired using the optical reviewing systems 10, 12, the scanning time of the transport system 2 can be saved, which in turn enables presence/absence of defects in the detection region to be confirmed within a short time.

### Fifth Embodiment

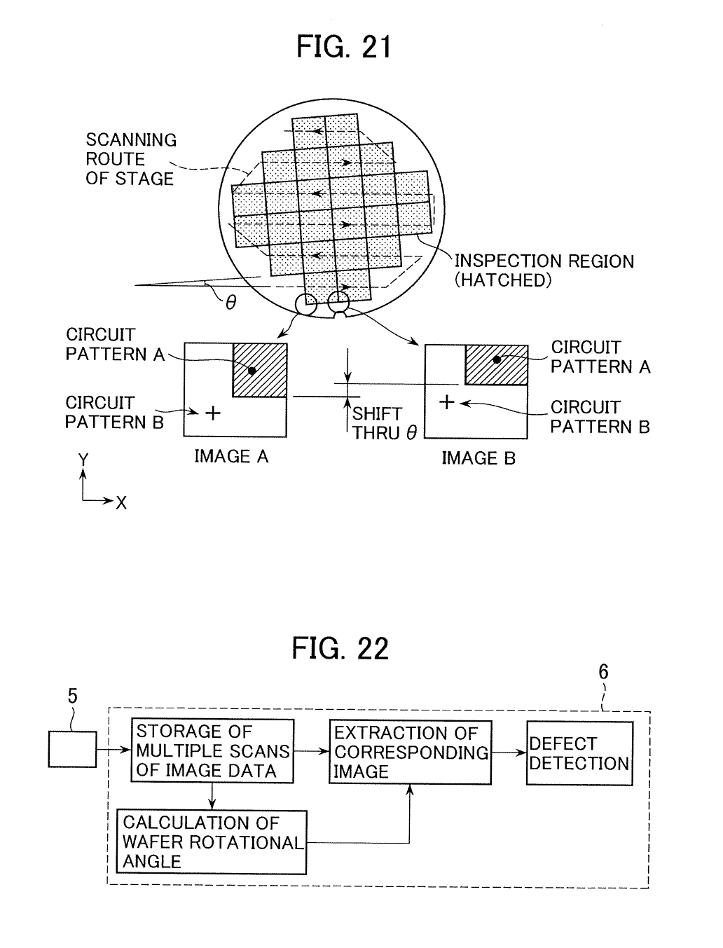

A further embodiment for reducing a defect inspection time is described below using FIGS. 21 and 22. An apparatus configuration in the present embodiment is the same as in FIG. 1. Although the precise alignment adjusting operation on the wafer 1 is conducted in FIG. 1, an example of inspection without precise alignment adjusting is described in the present embodiment.

First, an image of the wafer 1 is acquired by scanning with the transport system 2 in a manner similar to that of the first embodiment, and then the image is stored into the signal-processing unit 6. An image corresponding to a position of an integral multiple of a preset die size is extracted and a rotational angle of the wafer is calculated from a positional relationship between the image and a corresponding circuit pattern. Referring to FIG. 21, an image at a corner of a die during a start of scanning is image A and an image present at a corresponding position on an adjacent die is image B. This is an example in which images A and B were both formed by imaging of circuit patterns A and B. The wafer 1 usually undergoes pre-alignment adjusting by a pre-alignment mechanism not shown, so the circuit patterns do not significantly shift. The pre-alignment mechanism is also employed in other embodiments. The rotational angle of the wafer can be calculated from intra-image corner coordinates and die sizes of circuit patterns A on the acquired images A and B. It is desirable that the rotational angle of the wafer be calculated using a method applied to conventional precise-alignment adjusting.

After the calculation of the wafer rotational angle, as shown in FIG. 22, images at the positions corresponding to the same place of each die, calculated from the wafer rotational angle, are extracted from the image storage section of the signal-processing unit 6 and then transmitted for defect detection to the defect detection processing unit.

This enables defects to be detected without precise alignment adjusting, and thus the inspection time to be reduced.

Reviewing the detection region using as-inspected wafer images as described in other embodiments in addition to the present embodiment eliminates the need of the optical reviewing system 10. This reduces the moving distance required for the transport system 2, and thus enables manufacture of a compact, inexpensive inspection apparatus.

In the above apparatus configuration, inspection and the reviewing of the detection region are implemented within a short time. The description of each embodiment can also be applied to other embodiments.

### DESCRIPTION OF THE REFERENCE NUMERALS

1 . . . Wafer
2 . . . Transport system
3 . . . Illumination device
4 . . . Objective lens
5 . . . Detection unit
6 . . . Signal-processing unit
7 . . . ADC unit
8 . . . Input/output unit
9 . . . Transport information hold unit
10, 12 . . . Optical reviewing system
11 . . . Controller
13 . . . Shifter

1. A pattern defect inspecting apparatus that inspects defects in circuit patterns formed on a sample, the apparatus comprising:
scanning means that mounts the sample thereupon and moves in at least one direction with the mounted sample;
means that illuminates the sample;
imaging means that forms an optical image of the sample illuminated by the illumination means;
detection means including a detector to detect the optical image formed by the imaging means, the detector further converting the optical image into a signal;
defect detection means that detects defects on the sample by processing the signal detected by the detection means;
means that reviews a location detected by the defect detection means; and
means that displays a result obtained by the reviewing means,
wherein the detector has its operational speed controlled according to a particular speed of the scanning means.

2. The pattern defect inspecting apparatus according to claim 1,
wherein a control item relating to the detector is an accumulation time of the detector.

3. The pattern defect inspecting apparatus according to claim 1 or 2,
wherein the control of the detector is performed during acceleration/deceleration of the scanning means.

4. The pattern defect inspecting apparatus according to claim 1,
wherein the result display means displays the speed of the scanning means and an accumulation time.

5. The pattern defect inspecting apparatus according to claim 1,
wherein the result display means displays an inspection position.

6. The pattern defect inspecting apparatus,
wherein in accordance with information on the defect, the result display means changes a size of a symbol before displaying the symbol.

7. A pattern defect inspecting apparatus that inspects defects in circuit patterns formed on a sample, the apparatus comprising:
scanning means that mounts the sample thereupon and moves in at least one direction with the mounted sample;
means that illuminates the sample;
imaging means that forms an optical image of the sample illuminated by the illumination means;
detection means that detects the optical image formed by the imaging means, and then converts the optical image into an image;
defect detection means that detects defects on the sample by processing the image detected by the detection means;
means that reviews a location detected by the defect detection means;
means that displays a result obtained by the reviewing means; and
means that measures a position or speed of the scanning means,
wherein the image is corrected according to information acquired by the measuring means.

8. The pattern defect inspecting apparatus according to claim 7,
wherein the measuring means calculates speed or position deviations from an acceleration level of the scanning means.

9. A pattern defect inspecting apparatus that inspects defects in circuit patterns formed on a sample, the apparatus comprising:
scanning means that mounts the sample thereupon and moves in at least one direction with the mounted sample;
means that illuminates the sample;
imaging means that forms an optical image of the sample illuminated by the illumination means;
detection means that detects the optical image formed by the imaging means, and then converts the optical image into an image;
defect detection means that detects defects on the sample by processing the image detected by the detection means;
means that reviews a location detected by the defect detection means; and
means that displays a result obtained by the reviewing means,
wherein the result display means selectively displays a first image and second image acquired during imaging of the sample.

10. A pattern defect inspecting apparatus that inspects defects in circuit patterns formed on a sample, the apparatus comprising:
scanning means that mounts the sample thereupon and moves in at least one direction with the mounted sample;
means that illuminates the sample;
imaging means that forms an optical image of the sample illuminated by the illumination means;
detection means that detects the optical image formed by the imaging means, and then converts the optical image into an image;
means that calculates a rotational angle formed between the sample and a scanning direction of the scanning means, by processing the image detected by the detection means;
defect detection means that detects defects on the sample using the image corresponding to a position shifted through the angle calculated by the angle calculating means;
means that reviews a location detected by the defect detection means; and
means that displays a result obtained by the reviewing means.

11. The pattern defect inspecting apparatus according to claim 10,
wherein the result display means displays the rotational angle.

12. A pattern defect inspecting method used to inspect defects in circuit patterns formed on a sample, the method comprising the steps of:
scanning the sample by moving in at least one direction after mounting the sample;
illuminating the sample;
forming an optical image of the sample illuminated in the illumination step;
detecting the optical image formed in the image forming step, and then converting the optical image into a signal;
detecting defects on the sample by processing the signal detected in the detection step;
reviewing a location detected in the defect detection step; and
displaying a result obtained in the reviewing step,
wherein a detector used in the detection step has an operational speed controlled according to a particular speed in the scanning step.

13. The pattern defect inspecting method according to claim 12,
wherein a control item relating to the detector is an accumulation time of the detector.

14. The pattern defect inspecting method according to claim 11 or 12,
wherein the control of the detector is performed during acceleration/deceleration in the scanning step.

15. A pattern defect inspecting method used to inspect defects in circuit patterns formed on a sample, the method comprising the steps of:
scanning the sample by moving in at least one direction after mounting the sample;
illuminating the sample;
forming an optical image of the sample illuminated in the illumination step;
detecting the optical image formed in the image forming step, and then converting the optical image into an image;
detecting defects on the sample by processing the image detected in the detection step;
reviewing a location detected in the defect detection step;
displaying a result obtained in the reviewing step; and
measuring a position or speed in the scanning step,
wherein the image is corrected according to information obtained in the measuring step.

16. The pattern defect inspecting method according to claim 15,
wherein the measuring step further takes place to calculate a speed or position deviations from an acceleration level obtained in the scanning step.

17. A pattern defect inspecting method used to inspect defects in circuit patterns formed on a sample, the method comprising the steps of:
scanning the sample by moving in at least one direction after mounting the sample;
illuminating the sample;
forming an optical image of the sample illuminated in the illumination step;
detecting the optical image formed in the image forming step, and then converting the optical image into an image;
detecting defects on the sample by processing the image detected in the detection step;
reviewing a location detected in the defect detection step; and
displaying a result obtained in the reviewing step,
wherein the result display step takes place to selectively display images acquired during imaging of the sample.

18. A pattern defect inspecting method used to inspect defects in circuit patterns formed on a sample, the method comprising the steps of:
scanning the sample by moving in at least one direction after mounting the sample;
illuminating the sample;
forming an optical image of the sample illuminated in the illumination step;
detecting the optical image formed in the image forming step, and then converting the optical image into an image;
calculating a rotational angle formed between the sample and a scanning direction in the scanning step, by processing the image detected in the image detection step;
detecting defects on the sample using the image corresponding to a position shifted through the angle calculated in the angle calculation step;
reviewing a location detected in the defect detection step; and
displaying a result obtained in the reviewing step.

19. A display device used in a pattern defect inspecting apparatus, the display device acting to display:
a speed of scanning means which is movable in at least one direction after mounting a sample upon the scanning means; and
an accumulation time of a detector which detects light incident from a defect.

20. The display device,
wherein in accordance with information on the defect, the display device changes a size of a symbol before displaying the symbol.

21. A display device used in a pattern defect inspecting apparatus, the display device acting to display:
a rotational angle formed between a sample and a scanning direction of scanning means which is movable in at least one direction after mounting the sample upon the scanning means.
